(19) United States
(12) Patent Application Publication
(10) Pub. No.: US 2025/0078671 A1
(43) Pub. Date: Mar. 6, 2025

(54) Math Rounding Teaching Device

(71) Applicant: Jennifer McIntyre, Amissville, VA (US)

(72) Inventor: Jennifer McIntyre, Amissville, VA (US)

(21) Appl. No.: 18/817,497

(22) Filed: Aug. 28, 2024

Related U.S. Application Data
(60) Provisional application No. 63/579,313, filed on Aug. 29, 2023.

(51) Int. Cl. G09B 1/06

(52) U.S. Cl. CPC G09B 1/06

(57) ABSTRACT

The device is comprised of a simulative roller coaster body, wherein a teacher can then place a card with an initial number in the middle of the body, between a card with a lower place value number and a card with a higher place value number. Then, a student can insert a wheeled roller coaster cart into at least one opening of the body, wherein the opening represents a digit of the initial number. The coaster will then fall down the channel and into a receiving area which contains a card with a lower place value number or a higher place value number. The presence of the coaster in either receiving area indicates whether the initial number should be rounded down to the lower place value number or up to the higher place value number.

### CROSS-REFERENCE TO RELATED APPLICATION

The present application claims priority to, and the benefit of, U.S. Provisional Application No. 63/579,313, which was filed on Aug. 29, 2023, and is incorporated herein by reference in its entirety.

### FIELD OF THE INVENTION

The present invention relates generally to the field of teaching aids. More specifically, the present invention relates to a math rounding teaching device that resembles a rollercoaster, wherein users can physically interact with the device to learn whether to round a number up or down. Accordingly, the present disclosure makes specific reference thereto. Nonetheless, it is to be appreciated that aspects of the present invention are also equally applicable to other like applications, devices, and methods of manufacture.

### BACKGROUND

Rounding numbers is an essential skill for young children. However, many children find it hard to learn how to round numbers. This struggle can slow down their ability to progress in math. Existing ways of teaching rounding may not work for every student.

Therefore, there exists a long-felt need in the art for a device that can be used to teach students how to round numbers. There also exists a long-felt need in the art for a math rounding teaching device. More specifically, there exists a long-felt need in the art for a math rounding teaching device that teaches students how to round in an interactive and relatable manner that differs from existing rounding teaching styles.

The subject matter disclosed and claimed herein, in one embodiment thereof, comprises a math rounding teaching device. The device is comprised of a simulative roller coaster body, wherein a teacher can then place a card with an initial number in the middle of the body, between a card with a lower place value number and a card with a higher place value number. Then, a student can insert a wheeled roller coaster cart into at least one opening of the body, wherein the opening represents a digit of the initial number. The coaster will then fall down the channel and into a receiving area which contains a card with a lower place value number or a higher place value number. The presence of the coaster in either receiving area indicates whether the initial number should be rounded down to the lower place value number or up to the higher place value number.

In this manner, the math rounding teaching device of the present invention accomplishes all the forgoing objectives and provides a device that can be used to teach students how to round numbers. More specifically, the device teaches students how to round in an interactive and relatable manner that differs from existing rounding teaching styles.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a math rounding teaching device. The device is comprised of a simulative roller coaster body, wherein a teacher can then place a card with an initial number in the middle of the body, between a card with a lower place value number and a card with a higher place value number. In order to teach a student whether the initial number should be rounded to the lower place value number or the higher place value number, the student can insert at least one wheeled roller coaster cart into at least one opening of the body, wherein the opening represents a digit of the initial number. As a result of the angle of the first channel or second channel of the body, the coaster will then fall down the channel and into a receiving area near the card with the lower place value number or higher place value number. The presence of the coaster in either receiving area indicates whether the initial number should be rounded down to the lower place value number or up to the higher place value number.

Both channels are preferably hollow and have at least one opening that may represent any number and/or digit of any number. Each opening may be colored-coded to indicate said number or digit. In another embodiment, each channel is comprised of at least one indicator that can be placed near the opening on the channel. The indicator preferably resembles a roller coaster cart and may be color-coded to match the color of the opening. The indicator may also be comprised of at least one number which represents the number or digit the opening also corresponds to.

The device is also comprised of at least one wheeled coaster. The coaster preferably resembles a roller coaster cart and has wheels such that it can roll down the channel when placed into the channel via the opening. Each channel is comprised of at least one receiving area positioned at the bottom of the channel. Once the coaster is placed through the opening, the coaster rolls down the channel and is collected at (and retained within) the receiving area. The area is comprised of at least one card. The card is comprised of at least one lower place value or higher place value number than the initial number found on at least one card positioned at the apex of both channels. At least one digit of the initial number may be circled, underlined, highlighted, etc. in order to indicate to the user that said digit is the digit to be evaluated in order to determine whether the initial number should be rounded up to the higher place value number or down to the lower place value number.

The present invention is also comprised of a method of using the device. First, a device is provided comprised of a first channel comprised of at least one opening, at least one receiving area, and at least one indicator; a second channel comprised of at least one opening, at least one receiving area, and at least one indicator; a first card comprised of an initial number, a second card comprised of a lower place value number that is lower than the initial number, and a third card comprised of a higher place value number that is higher than the initial number; and at least one coaster. Then, a card with an initial number is selected and/or the initial number is written on the writing surface of the card and the card is secured at the apex of both channels. Then, at least one card with a lower place value number (wherein the number is lower than the initial number) is selected and/or the number is written on the writing surface of the card and the card is secured to the receiving area of the first channel. Next, at least one card with a higher place value number (wherein the number is higher than the initial number) is selected and/or the number is written on the writing surface of the card and the card is secured to the receiving area of the first channel. Then, a user can place at least one indicator on each channel near each opening of the channels wherein the indicator may be comprised of at least one number that may represent a number, a first digit of a number, or a second digit of a number. Then, a user can place the coaster in the corresponding opening of the channel as indicated by the indicator of the channel. Finally, a user can release the coaster, wherein the coaster then falls down the channel and into a receiving area of the channel and wherein the number present on near the receiving area is the number which the initial number should be rounded up or down to.

Accordingly, the math rounding teaching device of the present invention is particularly advantageous as it provides a device that can be used to teach students how to round numbers. More specifically, the device teaches students how to round in an interactive and relatable manner that differs from existing rounding teaching styles. In this manner, the math rounding teaching device overcomes the limitations of existing methods and devices used to teach number rounding known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a math rounding teaching device of the present invention in accordance with the disclosed architecture;

FIG. 2 illustrates an enhanced view of a first channel one potential embodiment of a math rounding teaching device of the present invention in accordance with the disclosed architecture;

FIG. 3 illustrates an enhanced view of a first receiving area of a first channel one potential embodiment of a math rounding teaching device of the present invention in accordance with the disclosed architecture;

FIG. 4 illustrates an enhanced view of a second receiving area of a second channel one potential embodiment of a math rounding teaching device of the present invention in accordance with the disclosed architecture;

FIG. 5 illustrates an enhanced view of a first receiving area of a first channel one potential embodiment of a math rounding teaching device of the present invention while receiving the coaster in accordance with the disclosed architecture;

FIG. 6 illustrates an enhanced view of a first receiving area of a first channel one potential embodiment of a math rounding teaching device of the present invention while receiving the coaster in accordance with the disclosed architecture;

FIG. 7 illustrates a flowchart of a method of using one potential embodiment of a math rounding teaching device of the present invention in accordance with the disclosed architecture; and

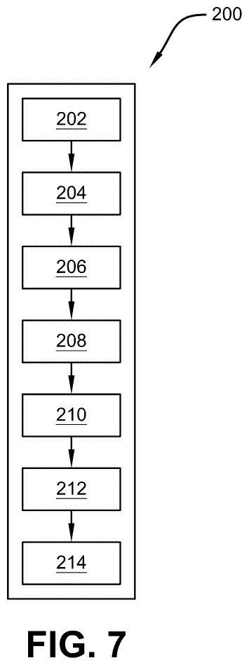

FIG. 8 illustrates a perspective view of one potential embodiment of a math rounding teaching device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to teach students how to round numbers. There also exists a long-felt need in the art for a math rounding teaching device. More specifically, there exists a long-felt need in the art for a math rounding teaching device that teaches students how to round in an interactive and relatable manner that differs from existing rounding teaching styles.

The present invention, in one exemplary embodiment, is comprised of a math rounding teaching device comprised of a simulative roller coaster body, wherein a teacher can then place a card with an initial number in the middle of the body, between a card with a lower place value number and a card with a higher place value number. Then, a student can insert a wheeled roller coaster cart into at least one opening of the body, wherein the opening represents a digit of the initial number. The coaster will then fall down the channel and into a receiving area which contains a card with a lower place value number or a higher place value number. The presence of the coaster in either receiving area indicates whether the initial number should be rounded down to the lower place value number or up to the higher place value number.

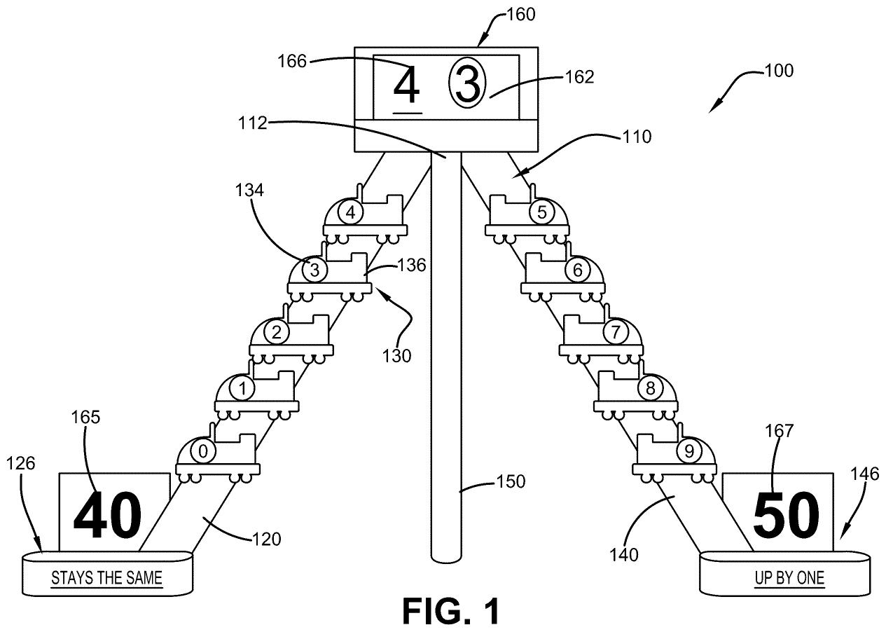

Referring initially to the drawings, FIG. 1 illustrates a perspective view of one potential embodiment of a math rounding teaching device 100 of the present invention in accordance with the disclosed architecture. The device 100 is comprised of a simulative roller coaster body 110. A teacher can then place a card 160 with an initial number 166 in the middle of the body 110, between a card 160 with a lower place value number 165 and a card 160 with a higher place value number 167. In order to teach a student whether the initial number 166 should be rounded to the lower place value number 165 or the higher place value number 167, the student can insert at least one wheeled roller coaster cart 170 into at least one opening 122,142 of the body 110, wherein the opening 122,142 represents a digit of the initial number 166. As a result of the angle of the first channel 120 or second channel 140 of the body 110, the coaster 170 will then fall down the channel 120,140 and into a receiving area 126,146 near the card 160 with the lower place value number 165 or higher place value number 167. The presence of the coaster 170 in either receiving area 126,146 indicates whether the initial number 166 should be rounded down to the lower place value number 165 or up to the higher place value number 167.

The body 110 may be made from any material known in the art. The body 110 is comprised of a first channel 120 and a second channel 140. The channels 120,140 are preferably angled such that the body 110 forms an angle less than 90 degrees in the shape of an inverted V-shape. In this manner, the body 110 generally resembles a hill/peak of a roller coaster. The channels 120,140 may be supported by at least one support leg 150.

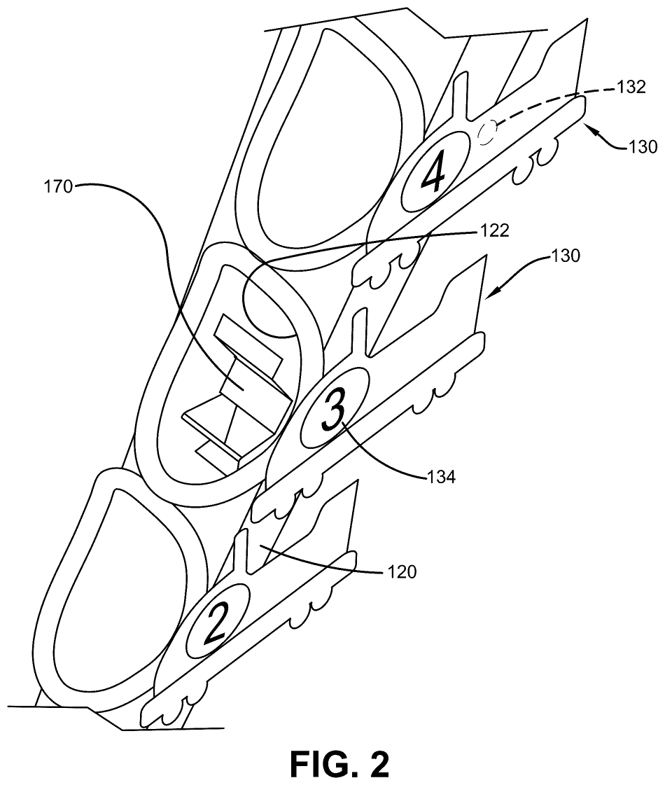

The first channel 120 is preferably hollow and may be an enclosed or an open channel. The channel 120 has at least one opening 122, as seen in FIG. 2. Each opening on the channel 120 may represent any number and/or digit of any number. Each opening 122 may be colored-coded to indicate said number or digit. In one embodiment, the openings 122 represent the digits 0, 1, 2, 3, and 4.

In another embodiment, the channel 120 is comprised of at least one indicator 130. The indicator 130 can be placed near the opening 122 on the channel 120. In one embodiment, the indicator 130 is comprised of at least one fastener 132 that allows the indicator 130 to attach to the channel 120. In another embodiment, the channel 120 is also comprised of at least one fastener 124 that allows the indicator 130 to attach to the channel 120 and/or receives the fastener 132 of the indicator 130. The fasteners 124,132 may be any type such as but not limited to magnet, hook, loop, adhesive, snap button, tongue, groove, etc.

The indicator 130 preferably resembles a roller coaster cart and may be color-coded to match the color of the opening 122. The indicator 130 may also be comprised of at least one number 134 which represents the number or digit the opening 122 also corresponds to. The number 134 may be printed on the indicator 130 but may also be written on a writing surface 136 of the indicator 130, such as but not limited to a dry-erase surface 136.

The second channel 140 is also preferably hollow and may be an enclosed or an open channel. The channel 140 has at least one opening 142. Each opening on the channel 140 may represent any number and/or digit of any number. Each opening 142 may be colored-coded to indicate said number or digit. In one embodiment, the openings 142 may represent the numbers 5,6,7,8, and 9.

In another embodiment, the channel 140 is comprised of at least one indicator 140. The indicator 130 can be placed near the opening 142 on the channel 140. In one embodiment, the indicator 130 is comprised of at least one fastener 142 that allows the indicator 130 to attach to the channel 140. In another embodiment, the channel 140 is also comprised of at least one fastener 144 that allows the indicator 130 to attach to the channel 140 and/or receives the fastener 132 of the indicator 130. The fasteners 144,132 may be any type such as but not limited to magnet, hook, loop, adhesive, snap button, tongue, groove, etc. The indicator 130 preferably resembles a roller coaster cart and may be color-coded to match the color of the opening 142. The indicator 130 may also be comprised of at least one number 134 which represents the number or digit the opening 142 also corresponds to. The number 134 may be printed on the indicator 130 but may also be written on a writing surface 136 of the indicator 130, such as but not limited to a dry-erase surface 136.

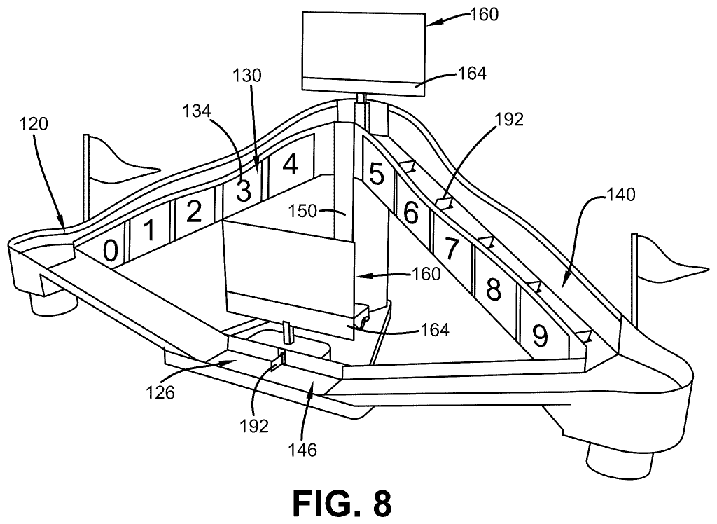

The device 100 is also comprised of at least one wheeled coaster 170. The coaster 170 preferably resembles a roller coaster cart and has wheels such that it can roll down the channel 120,140 when placed into the channel via the opening 122,142. In one embodiment, each channel 120,140 may be comprised of a stopper 192 (as seen in FIG. 8) of any configuration that is positioned within the channel and that prevents movement of the coaster 170 within the channel 120,140 until the stopper 192 is press and/or disengaged. A stopper 192 may also be present in each or between each receiving area 126,146 to prevent coasters 170 from hitting each other when finished riding in each channel 120,140.

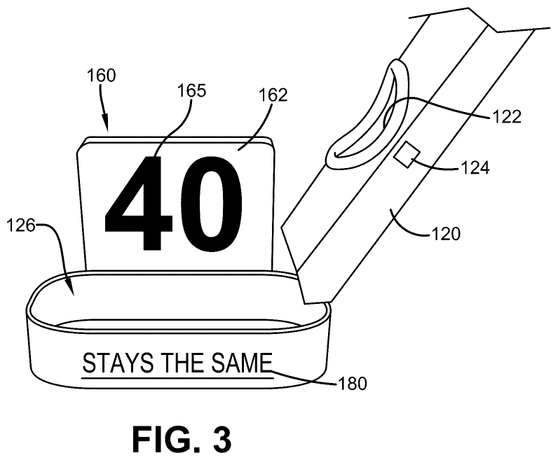

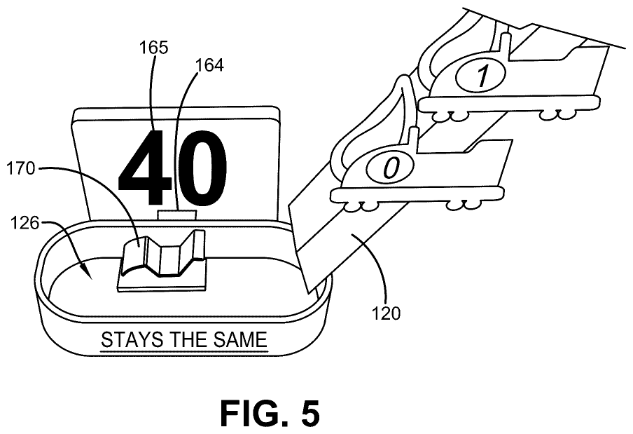

The first channel 120 is also comprised of at least one receiving area 126 positioned at the bottom of the channel 120, as seen in FIG. 3. Once the coaster 170 is placed through the opening 122, the coaster 170 rolls down the channel 120 and is collected at (and retained within) the receiving area 126, as seen in FIG. 5. The area 126 is comprised of at least one card 160. The card 160 is comprised of at least one fastener 164 that allows the card 160 to be attached to the receiving area 126. The fastener 164 may be any type known in the art such as but not limited to magnet, hook, loop, adhesive, snap button, tongue, groove, etc.

The card 160 is comprised of at least one lower place value number 165 that is lower than at least one initial number 166 found on at least one card 160 positioned at the apex 112 of both channels 120,140. The number 165 may be printed on the card 160 but may also be written on the card 160 via a writing surface 162, such as but not limited to a dry-erase surface.

Furthermore, the card 160 found at the apex 112 is comprised of the initial number 166. At least one digit of the initial number 166 may be circled, underlined, highlighted, etc. in order to indicate to the user that said digit is the digit to be evaluated in order to determine whether the initial number 166 should be rounded up to the higher place value number 167 or down to the lower place value number 165.

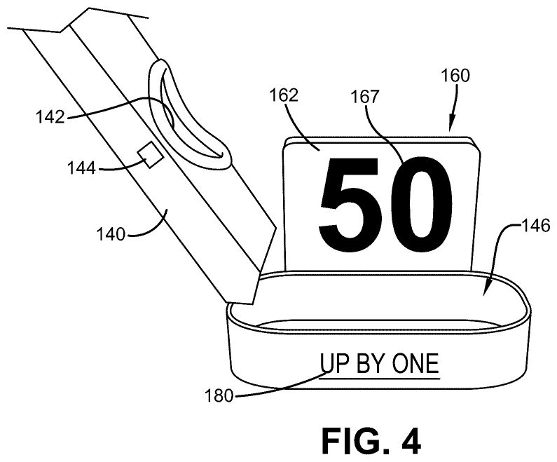

The second channel 140 is also comprised of at least one receiving area 146 positioned at the bottom of the channel 140, as seen in FIG. 4. Once the coaster 170 is placed through the opening 142, the coaster 170 rolls down the channel 140 and is collected at (and retained within) the receiving area 146. The area 146 is comprised of at least one card 160. The card 160 is comprised of at least one fastener 164 that allows the card 160 to be attached to the receiving area 146. The fastener 164 may be any type known in the art such as but not limited to magnet, hook, loop, adhesive, snap button, tongue, groove, etc.

The card 160 is comprised of at least one higher place value number 167 that is higher than at least one initial number 166 found on at least one card 160 positioned at the apex 112 of both channels 120,140. The card 160 is comprised of at least one fastener 164 that allows the card 160 to be attached at the apex 112. In one embodiment, the card 160 may be positioned in any location on the device 100. The fastener 164 may be any type known in the art such as but not limited to magnet, hook, loop, adhesive, snap button, tongue, groove, etc. In one embodiment, the fastener 164 is a rotating fastener that allows the card 160 to rote 360 degrees relative to a vertical or horizontal axis of the device 100. The number 167 may be printed on the card 160 but may also be written on the card 160 via a writing surface 162, such as but not limited to a dry-erase surface.

The present invention is also comprised of a method of using 200 the device 100. First, a device 100 is provided comprised of a first channel 120 comprised of at least one opening 122, at least one receiving area 126, and at least one indicator 130; a second channel 140 comprised of at least one opening 142, at least one receiving area 146, and at least one indicator 130; a first card 160 comprised of an initial number 166, a second card 160 comprised of a lower place value number 165 that is lower than the initial number 166, and a third card 160 comprised of a higher place value number 167 that is higher than the initial number 166; and at least one coaster 170 [Step 202]. Then, a card 160 with an initial number 166 is selected and/or the initial number 166 is written on the writing surface 162 of the card 160 and the card 160 is secured at the apex 112 of both channels 120,140 [Step 204]. Then, at least one card 160 with a lower place value number 165 (wherein the number 165 is lower than the initial number 166) is selected and/or the number 165 is written on the writing surface 162 of the card 160 and the card 160 is secured to the receiving area 126 of the first channel 120 [Step 206]. Next, at least one card 160 with a higher place value number 167 (wherein the number 167 is higher than the initial number 166) is selected and/or the number 167 is written on the writing surface 162 of the card 160 and the card 160 is secured to the receiving area 126 of the first channel 120 [Step 208]. Then, a user can place at least one indicator 130 on each channel 120,140 near each opening 122,142 of the channels 120,140, wherein the indicator 130 may be comprised of at least one number 134 that may represent a number, a first digit of a number, or a second digit of a number [Step 210]. Then, a user can place the coaster 170 in the corresponding opening 122,142 of the channel 120,140 as indicated by the indicator 130 of the channel 122,142 [Step 212]. Finally, a user can release the coaster 170, wherein the coaster 170 then falls down the channel 120,140 and into a receiving area 126,146 of the channel 120,140, and wherein the number 165,167 present on/near the receiving area 126,146 is the number which the initial number 166 should be rounded up or down to [Step 214].

By way of example, the method 200 is further described below. In one embodiment, the initial number 166 is “43”. The user must decide to round “43” down to “40” (the lower place value number 165) or up to “50” (the higher place value number 167). The user places the card 160 with the initial number 166 of “43” at the apex 112 of both channels 120,140, places the card 160 with the lower place value number 165 of “40” at the first receiving area 126, and places the card 160 with the higher place value number 167 of “50” at the second receiving area 146. Then, at least one indicator 130 with at least one number 134 is placed near each opening 122,142 on each channel 120,140. In this example, each number 134 of each indicator 130 represents the second digit of the numbers between “40” and “50”. Because the initial number 166 is “43”, a user will place the coaster 170 in the opening 122 of the first channel 120 with the indicator 130 that has the number 134 “3”. This corresponds to the number “43”. Once a user releases the coaster 170, it will fall down the channel 120 to the receiving area 126 where the card 160 with “40” is present. This indicates to the user that the number “43” should be rounded down to “40”.

In one embodiment, each area 126,146 may be comprised of at least one indicia 180. The indicia 180 of the first area 126 instructs the user that if the coaster 170 is present at this area 126 then the initial number 166 should be rounded down to the lower place value number 165 present on the card 160 at the receiving area 126. The indicia 180 of the second area 146 instructs the user that if the coaster 170 is present at this area 146 then the initial number 166 should be rounded up to the higher place value number 167 present on the card 160 at the receiving area 146.

In different embodiments, the exact numbers 165,166,167, 134 used may differ and may be any number. The rounding methodology used in the method 200 may also differ. For example, users can use the device 100 to learn how to round to the nearest decimal place, whole number, even number, odd number, multiple (ex. multiple of 10), etc.

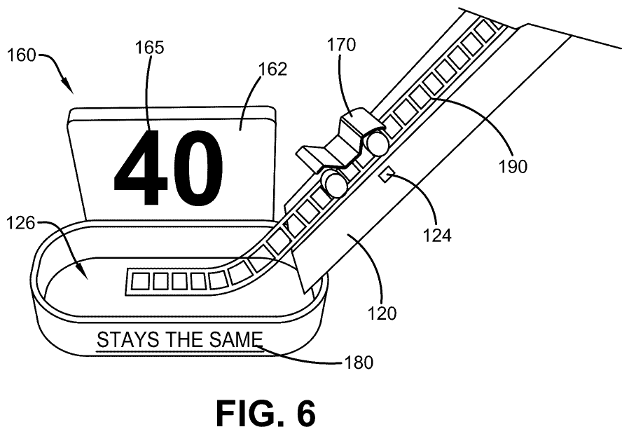

In one embodiment, the channels 120,140 may be comprised of at least one track 190, as seen in FIG. 6. The track 190 removably receives the coaster 170 and wherein the track 190 ends at each receiving area 126,146. In this embodiment, the channels 120,140 have no openings 122,142 and the indicators 130 are positioned on the channels 120,140 at various points along each track 190.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “math rounding teaching device” and “device” are interchangeable and refer to the math rounding teaching device 100 of the present invention.

Notwithstanding the forgoing, the math rounding teaching device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the math rounding teaching device 100 as shown in the FIGS. are for illustrative purposes only, and that many other sizes and shapes of the math rounding teaching device 100 are well within the scope of the present disclosure. Although the dimensions of the math rounding teaching device 100 are important design parameters for user convenience, the math rounding teaching device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A math rounding teaching device comprising:
a first channel that forms an angle less than 90 degrees with a second channel;
a first opening positioned on the first channel;
a second opening positioned on the second channel;
a first receiving area positioned at an end of the first channel;
a second receiving area positioned at an end of the second channel;
an indicator comprised of a number;
a first card comprised of a first number;
a second card comprised of a second number lower than the first number;
a third card comprised of a third number higher than the first number; and
a coaster.

2. The math rounding teaching device of claim 1, wherein the first card attaches at an apex of the first channel and the second channel.

3. The math rounding teaching device of claim 1, wherein the second card attaches to the first receiving area.

4. The math rounding teaching device of claim 1, wherein the third card attaches to the second receiving area.

5. The math rounding teaching device of claim 1, wherein the indicator attaches to the first channel.

6. The math rounding teaching device of claim 1, wherein the indicator attaches to the second channel.

7. The math rounding teaching device of claim 1, wherein the number of the indicator is comprised of a digit.

8. The math rounding teaching device of claim 1, wherein the first card is comprised of a first writing surface, the second card is comprised of a second writing surface, and the third card is comprised of a third writing surface.

9. The math rounding teaching device of claim 1 further comprised of a support.

10. The math rounding teaching device of claim 1, wherein the coaster resembles a roller coaster cart.

11. The math rounding teaching device of claim 1, wherein the indicator resembles a roller coaster cart.

12. The math rounding teaching device of claim 1, wherein the first opening is comprised of a color.

13. The math rounding teaching device of claim 12, wherein the color is the same as a color of the indicator.

14. A math rounding teaching device comprising:
a first channel that forms an angle less than 90 degrees with a second channel;
a first receiving area positioned at an end of the first channel;
a second receiving area positioned at an end of the second channel;
an indicator comprised of a number;
a first card comprised of a first number;
a second card comprised of a second number lower than the first number;
a third card comprised of a third number higher than the first number; and
a coaster.

15. The math rounding teaching device of claim 14, wherein the first channel is comprised of a first track.

16. The math rounding teaching device of claim 15, wherein the first track receives the coaster.

17. The math rounding teaching device of claim 14, wherein the second channel is comprised of a second track.

18. The math rounding teaching device of claim 17, wherein the second track receives the coaster.

19. A method of using a math rounding teaching device, the method comprising the following steps:
providing a math rounding teaching device comprised of a first channel comprised of a first receiving area and a first indicator, a second channel comprised of a second receiving area and a second indicator, a first card comprised of a target number, a second card comprised of a lower number that is lower than the target number, a third card comprised of a higher number that is higher than the target number, and a coaster;
placing the first card at an apex of the first channel and the second channel;
placing the second card at the first receiving area;
placing the third card at the second receiving area;
placing the first indicator on the first channel;
placing the second indicator on the second channel; and
placing and releasing the coaster on the first channel or the second channel.

20. The method of using a math rounding teaching device of claim 19 further comprised of a step of placing the coaster in a first opening of the first channel or a second opening of the second channel.
